(19) United States
(12) Patent Application Publication
(10) Pub. No.: US 2009/0077737 A1
(43) Pub. Date: Mar. 26, 2009

(54) RAIL-MOUNTED PATIENT OR PERSON LIFT

(75) Inventors: Klaus B. Dyhr, Hvalso (DK); Jan S. Kristoffersen, Naestved (DK); Steen Hansen, Slagelse (DK); Jan E. Vest, Arhus (DK)

Correspondence Address: KLEIN, O'NEILL & SINGH, LLP, 43 CORPORATE PARK, SUITE 204, IRVINE, CA, 92606, US

(73) Assignee: Invacare EC-Hong A/S, Hong (DK)

(21) Appl. No.: 10/588,047

(22) PCT Filed: Feb. 7, 2005
(86) PCT No.: PCT/DK2005/000083

§ 371 Date: Dec. 1, 2008

(30) Foreign Application Priority Data
Feb. 6, 2004 (EP) 04388006.1

(51) Int. Cl. A61G 7/10

(52) U.S. Cl. 5/85.1

(57) ABSTRACT

An electrically powered, rail-mounted patient lift includes a carriage for displacement along an overhead rail and a housing. The housing includes an electric motor having an output shaft and two belts suspended from the housing for the mounting of a patient support such as a sling or the like. Two belt-receiving rollers, each having an outer cylindrical surface for receiving a respective lifting belt, co-operate with the output shaft of the electrical motor for rotating in opposite directions at the same rotational speed driven by the output shaft, thereby collecting the belts when rotating the output shaft in one direction and discharging the belts when rotating the output shaft in the opposite direction. The housing further includes a power supply unit for the delivery of electrical power to the electrical motor from a battery power supply or alternatively, a mains supply.

The present invention relates to a novel electrically powered, rail-mounted patient or person lift.

Within the technical field of hospital equipment and nursing equipment, a variety of patient or person lifts exist. A particular kind of patient or person lifts is rail-mounted and comprises a carriage for displacement along an overhead rail. Examples of patient or person lifts of this kind are described in among others U.S. Pat. No. 6,523,295, U.S. Pat. No. 5,158,188 U.S. Pat. No. 5,530,976, U.S. Pat. No. 5,530,976, U.S. Pat. No. 5,553,335, WO 8809159, WO 9709896, WO 03064312, DE 4337527 and EP 0 361 397. Reference is made to the above patent applications and patents and the above US patents are hereby incorporated in the present specification by reference.

The conventional rail-mounted patient or person lift comprises a carriage including a pair wheels which co-operate with the overhead rail for the displacement of the carriage along the overhead rail. In most conventional patient or person lifts, a single belt is used, which belt is received on a roller powered by a motor for raising or lowering a yoke which is suspended in the belt in which yoke a patient or person sling is suspended by means of which sling a person may be shifted from e.g. a bed to a chair or visa versa. Certain patient or person lifts are manually moved along the overhead rail, whereas others are provided with a motor for the displacement of the carriage along the overhead rail. The single belt patient or person lift is of a fairky simple structure, however, the structure suffers from certain drawbacks, in particular the risk that the sling, which is suspended in the yoke may start swinging which may cause discomfort to the patient or person suspended in the sling. Furthermore, the use of a single belt results in that the single roller, by means of which the belt is suspended has to be able to stand the weight of the maximum load and similarly, the one belt must be capable of carrying the weight of the patient or person and also the yoke and the sling. In DE 4337527, a rail-mounted patient or person lift is described, in which a motor drives a single shaft, on which two rollers are mounted for winding or unwinding respective lifting belts. Since a common through-going shaft causes both rollers to rotate in the same direction, the actuation of the motor provides a major torque, which causes the entire lift to generate a large momentum in the rail and may in the one alternative cause the lift to turn side wise causing incomfort to the patient or person hanging in the belts or in the alternative, generate such extreme forces in the supporting rail, that the rail may be deformed or be loosened from its suspension.

The above drawbacks have to certain extents been eliminated in a structure described in U.S. Pat. No. 5,553,335 according to which structure a single roller is used for the winding and unwinding of two belts, the one being positioned on top of the other. As far as the risk of causing swinging of the patient or person suspended in the sling is concerned, the structure eliminates this risk, however, the use of a single roller for the winding of the two belts, the one being positioned on top of the other does not improve the function of the lift for the reason that during winding of the two belts on a single roller, the belt positioned on top of the other is shortened as compared to the belt underlying the first-mentioned belt and in doing so, the patient or person is caused to tilt sidewise. Consequently, the patient may feel discomfort when raised or lowered by means of this known two-belt structure and as far as the mechanical impact and requirements of load carrying capability of the single roller is concerned, no improvement as compared to the prior art single belt structures has been provided by means of this two belt structure.

An object of the present invention is to provide an electrically powered, rail-mounted patient or person lift, which is of a simple structure and provides distinct advantages as compared to the above-described single belt lift structures and eliminates the discomfort of the above-described single roller two belt structure known from U.S. Pat. No. 5,553,335 and further provide distinct advantages as to load bearing capability and strength as compared to the prior art single belt patient or person lifts.

It is a particular advantage of the patient or person lift according to the present invention that the lift may be readily adjusted to the size of the patient or person without necessitating the use of an intermediate yoke in which the sling is suspended.

A particular feature of the present invention relates to the fact that the carriage is constructed as a two part carriage, the one carriage part including the power supply and the other carriage part including the lifting motor. In addition, separate units may be provided constituting a traction unit, which may be used for pushing and pulling the one or two part carriage relative to its supporting rail. Alternatively, the carriage itself or the one carriage part or alternatively the other carriage part of the two part carriage structure may include the drive motor for the displacement of the carriage along the overhead rail.

The above objects, the above advantages and the above feature together with numerous other objects, features and advantages, which will be evident from the below detailed description of a presently preferred embodiment of the patient or person lift according to the present invention is obtained by means of an electrically powered, rail-mounted patient or person lift comprising: a carriage for displacement along an overhead rail and having a housing, said housing including:
an electric motor having an output shaft,
   two lifting belts suspended from said housing for the mounting of a patient or person support such as a sling or the like,
two belt-receiving rollers, each having an outer cylindrical surface for receiving a respective lifting belt and co-operating with said output shaft of said electrical motor for rotating in opposite directions at the same rotational speed driven by said output shaft, thereby collecting said belts when rotating said output shaft in the one direction and discharging said belts when rotating said output shaft in the opposite direction, and
a power supply unit for the delivery of electrical power to said electrical motor from a battery power supply or alternatively, a mains supply.

The provision of two separate rollers from which the patient or person support such as a conventional sling is suspended eliminates, as compared to the prior art single belt patient or person lifts, the use of the intermediate yoke for connecting the sling to the one belt, which yoke in itself may cause injury to the patient or person using the lift or a person helping a patient or person sitting in the sling as the yoke may unintentionally swing around its vertical axis and at the same time eliminates the risk that the sling supporting the patient or person may start swinging round a vertical axis which may cause discomfort to the patient or person and furthermore may cause that the patient or person may feel unsafe while suspended in the single belt. The patient or person using the patient or person lift according to the present invention is given a feeling of stability and comfort.

The provision of two rollers further eliminates the disadvantage of the prior art two belt structure known from U.S. Pat. No. 5,553,335 by allowing the two belts to be evenly collected on the two belt receiving rollers, thereby preventing any tilting of the patient or person suspended in the two belts.

As distinct from the two belt structure known from U.S. Pat. No. 5,553,335, the belts are used for the suspension of the patient or person support, e.g. a sling, whereas in the prior art two belt structure known from U.S. Pat. No. 5,553,335, the belts are used for overhead mounting in e.g. a ceiling fixture. Whereas the prior art two belt lift structure known from U.S. Pat. No. 5,553,335 is of a structure in which the housing of the lift constitutes the yoke in which the sling is suspended, which increases the overall weight of the entire lift, the teachings of the present invention provides a reduced weight to be carried by the lift as the two belts are used for the suspension of the patient or person support such as a sling without the use of an intermediate yoke or the use of the housing shown in U.S. Pat. No. 5,553,335.

As the electrically powered rail-mounted patient or person lift includes its own power supply unit, the lift is preferably separated from the AC mains supply which eliminates risk of electrical chock originating from the AC mains supply. The use of a battery supply is highly advantageous, however, according to an alternative embodiment of the patient or person lift according to the present invention, the lift is powered from the AC mains supply directly in particular in countries or continents in which the AC mains voltage is fairly low, such as of the order of 110-130V.

The electric motor of the patient or person lift may be constituted by a single phase or multi-phase AC motor powered by an inverter included in the power supply unit or powered from the AC mains supply directly or through a transformer.

In the presently preferred embodiment of the patient or person lift according to the present invention, the electric motor is a DC motor and for providing a complete separation of the lift from the AC mains supply for reducing the risk of electrical chocks, the power supply unit is constituted by a battery supply including one or more rechargeable batteries.

According to a particular feature of the electrically powered, rail mounted patient or person lift according to the present invention, the battery power supply unit including rechargeable batteries is only operable provided the batteries are charged to a certain level and any operation of the electrically powered, rail-mounted patient or person lift is blocked provided the rechargeable batteries are to be charged or are charged from an AC mains supply charger.

Furthermore, the rechargeable batteries may be housed within a separate battery power pack which may be included in a separate housing of the carriage of the patient or person lift or may be removed from a battery power pack housing and recharged in a separate mains supply powered recharging station.

The operation of the lift including the actuation of the motor driving the two belt receiving rollers characteristic of the lift according to the present invention is preferably carried out by means of a remote control unit which may be connected in a wire connection to the housing or communicating with the power supply unit through a wireless link as is per se well known in the art from e.g. television sets, DVD players, video cassette recorders etc. Provided a wired remote control unit be used, the wired connection between the power supply unit and the remote control unit may be used for the supply of power from the AC mains supply power recharging station to the rechargeable batteries provided the rechargeable batteries be housed in the housing of the patient or person lift or in a separate housing of the carriage alternatively, provided the remote control unit includes a receptor for receiving a separate rechargeable battery the wired connection between the power supply unit and the remote control unit may be used for the supply of power from the rechargeable power pack to the power supply unit of the patient or person lift.

The mechanical linking and power transmission between the output shaft of the electric motor and the two belt receiving rollers may be established in accordance with any per se well known transmission technique including gear sets, transmission belts, worm gear etc. According to the presently preferred embodiment of the lift according to the present invention, the belt receiving rollers are journalled on respective journalled axes and have toothed wheels co-operating with a pinion of the output shaft for the transmission of rotational power from the output shaft to the belt receiving rollers. Further advantageously, for improving the stability of the transmission from the motor to the belt receiving rollers and for preventing the rollers from jamming in their bearings due to an uneven force impact to the rollers, the rollers preferably each have two toothed wheels each sandwiching a respective belt receiving roller.

According to a particular feature of the lift according to the present invention, the two belts characteristic of the present invention and serving for the suspension of the patient or person suspension, e.g. a sling or the like may be adjusted for allowing the width between the two belts to be adjusted to the size of a person suspended in the patient or person supporting sling or similar structure. It is to be understood that the belts preferably should be kept parallel while raising and lowering the patient or person suspended in the belts to prevent any other forces to be imposed to the rollers than the raising or lowering forces and for improving the safety and comfort of the patient or person suspended in the patient or person suspending sling.

For obtaining the ability of adjusting the belts to the patient or person or rather the width of the patient or person suspended in the lift, the belts are guided from said belt receiving rollers round positionable guiding pins.

The parallel guiding of the two belts from the two belt receiving rollers allows the patient or person to be raised or lowered without causing the patient or person to feel any discomfort due to any unintentional swinging round a vertical axis during the raising or lowering.

According to a particular feature of the rail mounted patient or person lift according to the present invention, the patient or person lift may be provided as a two-part structure as the housing of the carriage of the rail-mounted patient or person lift according to the present invention is preferably divided into a two part housing structure having a top part including a pair of wheels for co-operating with said overhead rail and a bottom part including said electric motor and said two belt receiving rollers, said bottom part being journalled rotatably round a vertical axis relative to said top part. The above feature relating to the division of the rail mounted patient or person lift into a two part structure provides several advantages. First of all, the two part structure allows the top part to be included in a permanently mounted rail, e.g. at a nursing hospital and the bottom part including the electric motor and the belt receiving rollers are only mounted in its co-operating top part provided the patient or person living in the room in question is need for using the patient or person lift. Consequently, a permanent installation of the top part in a concealed ceiling structure may be provided of all rooms of the hospital or nursing home and at the other hand, only those patients or persons needing the assistance of the patient or person lift need to have one bottom part mounted in their own room. This feature consequently allows a remarkable saving of components and equipment and at the same time allows easy service of the bottom part constituting the motor unit of the patient or person lift.

The provision of the two part structure also allows the patient or person sitting in the sling supported by the patient or person lift to be turned sidewise, e.g. when shifting the patient or person from a bed to a chair or visa versa due to the presence of the journalled mounting of the bottom part relative to the top part.

It is, however, mandatory that the disconnection between the bottom and the top part may not be accomplished unintentionally for obvious safety reasons.

The invention is now to be further described with reference to the drawings, in which:

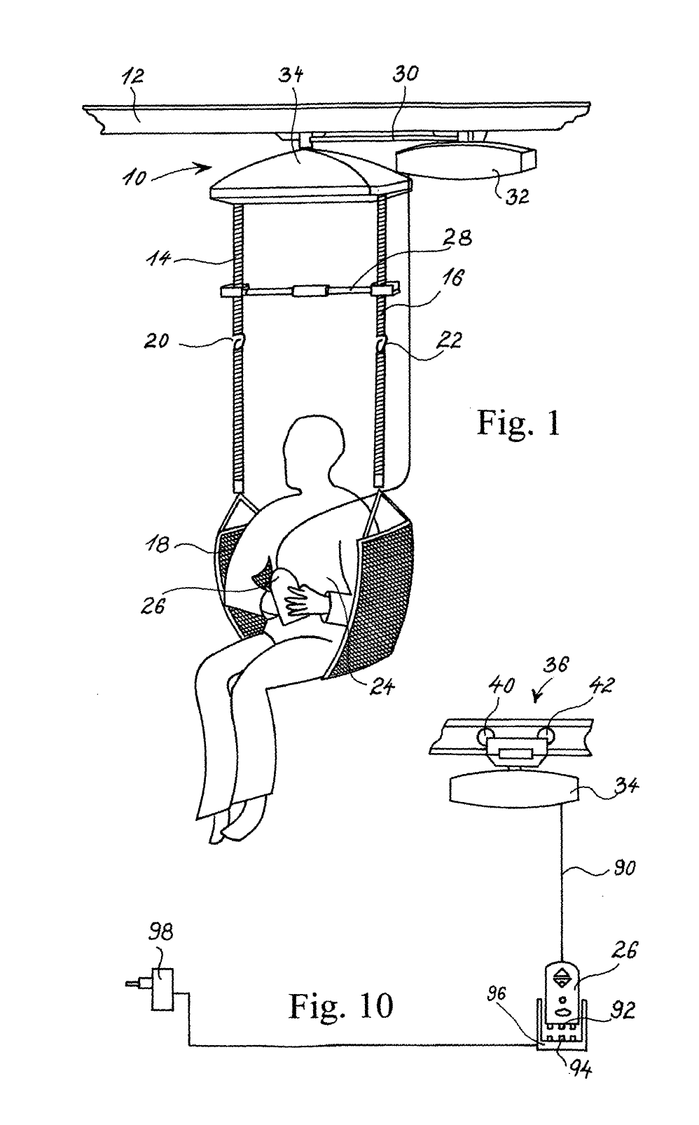

FIG. 1 is a perspective, schematic view of a first and advantageous embodiment of a rail-mounted patient or person lift according to the present invention illustrating the intention or use of the lift by the suspension of a patient or person in a sling from two belts of a carriage of the lift,

FIG. 2 is a vertical sectional view of the carriage illustrating the two belts characteristic of the lift according to the present invention.

FIG. 3 is a horizontal, sectional view of the carriage,

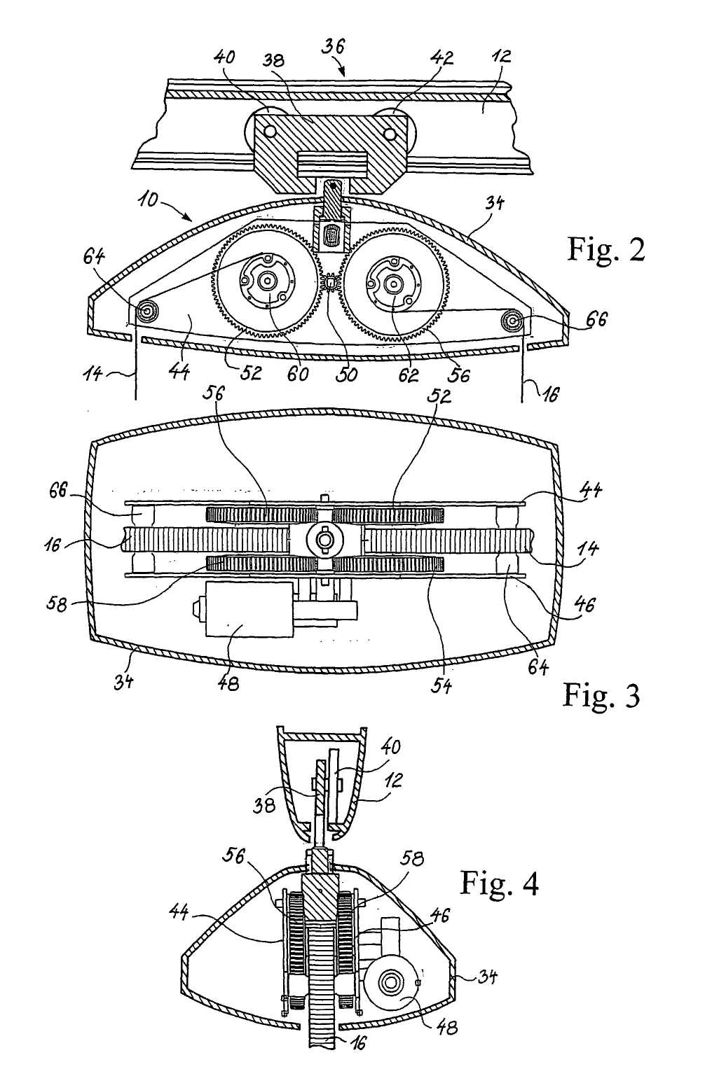

FIG. 4 is a transversal, vertical, sectional view of the carriage,

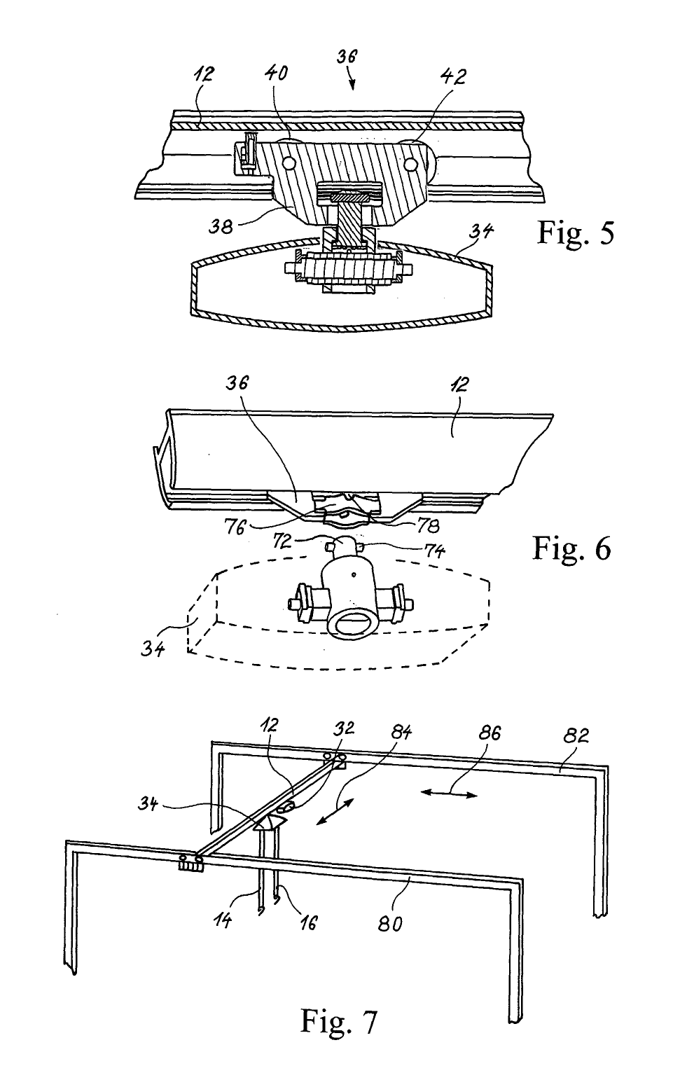

FIG. 5 is a vertical, sectional view of the carriage illustrating a detail of a displacement driving motor of the carriage,

FIG. 6 is a perspective and schematic view of a detail of a bayonet connection between a bottom part and a top part of the carriage,

FIG. 7 is a perspective, schematic view of a rail suspension system of the rail-mounted lift,

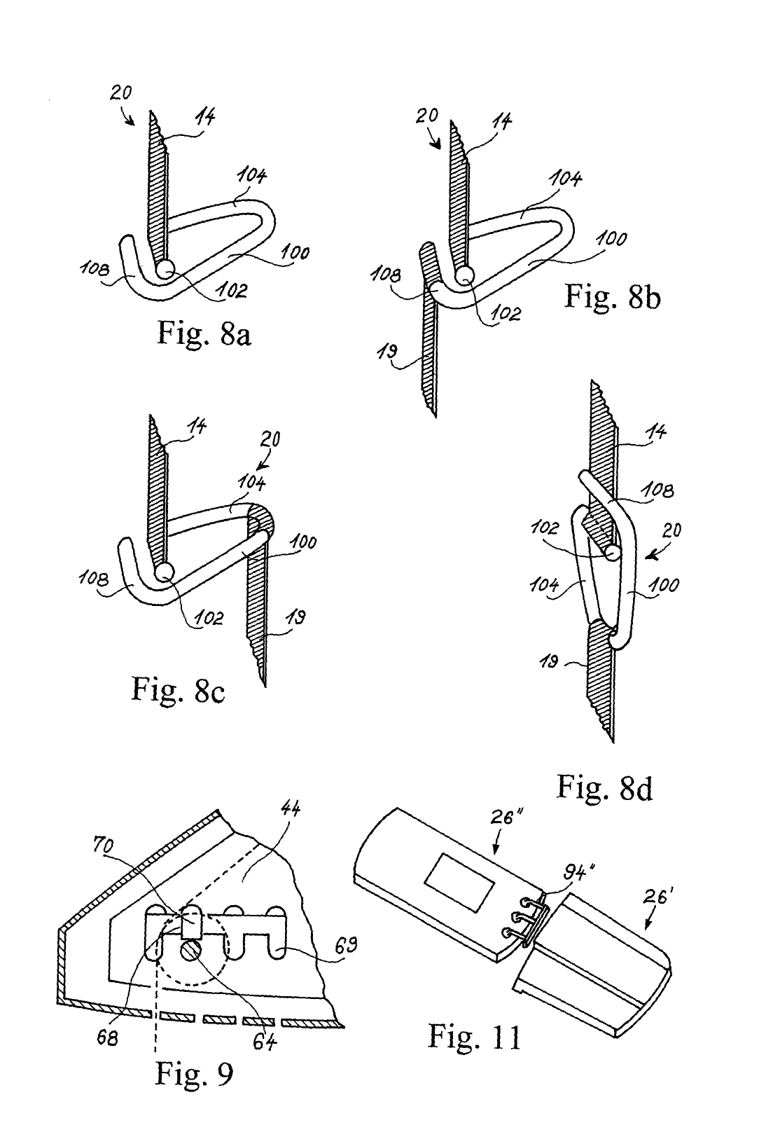

FIGS. 8a, 8b, 8c and 8d are schematic views illustrating a self-blocking feature of a sling suspension fitting of the one belt of the lift shown in FIG. 1,

FIG. 9 is a schematic view illustrating a detail of the carriage of the lifts allowing the adjustment of the spacing between the two belts of the lift,

FIG. 10 is a diagrammatic view of the electric power system of the lift,

FIG. 11 is a perspective and schematic view of a replaceable battery power package of the lift,

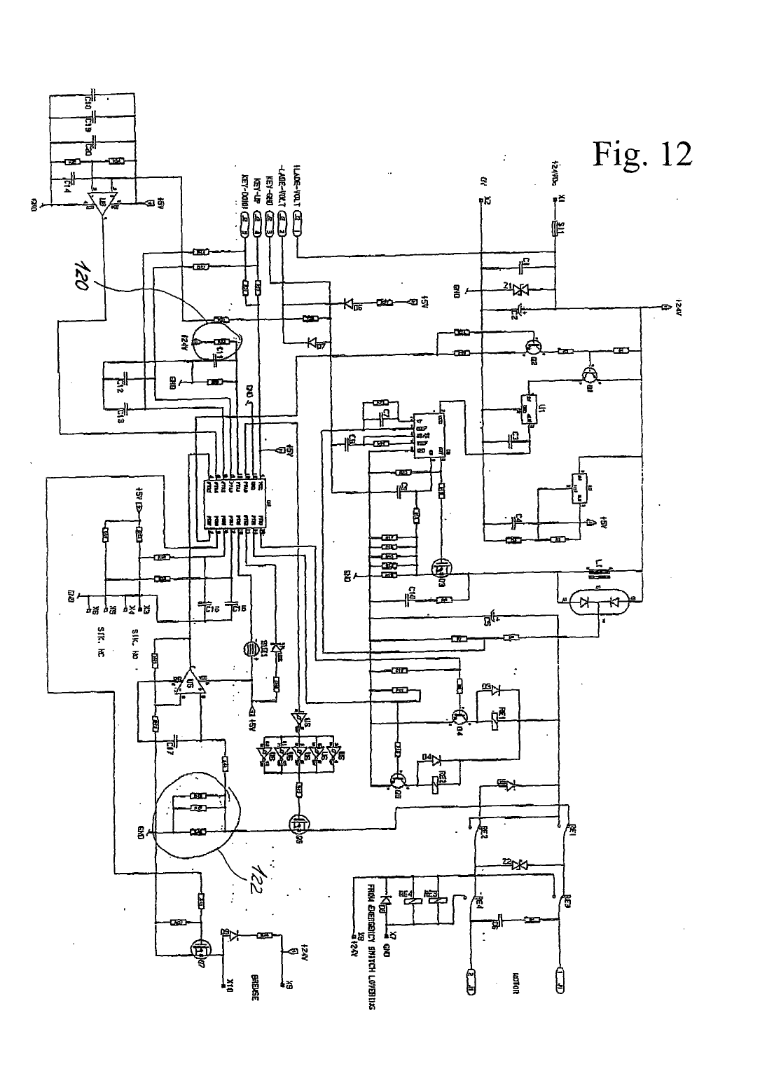

FIG. 12 is a schematic view of the electric diagram of the power supply unit of the first embodiment of the lift according to the present invention,

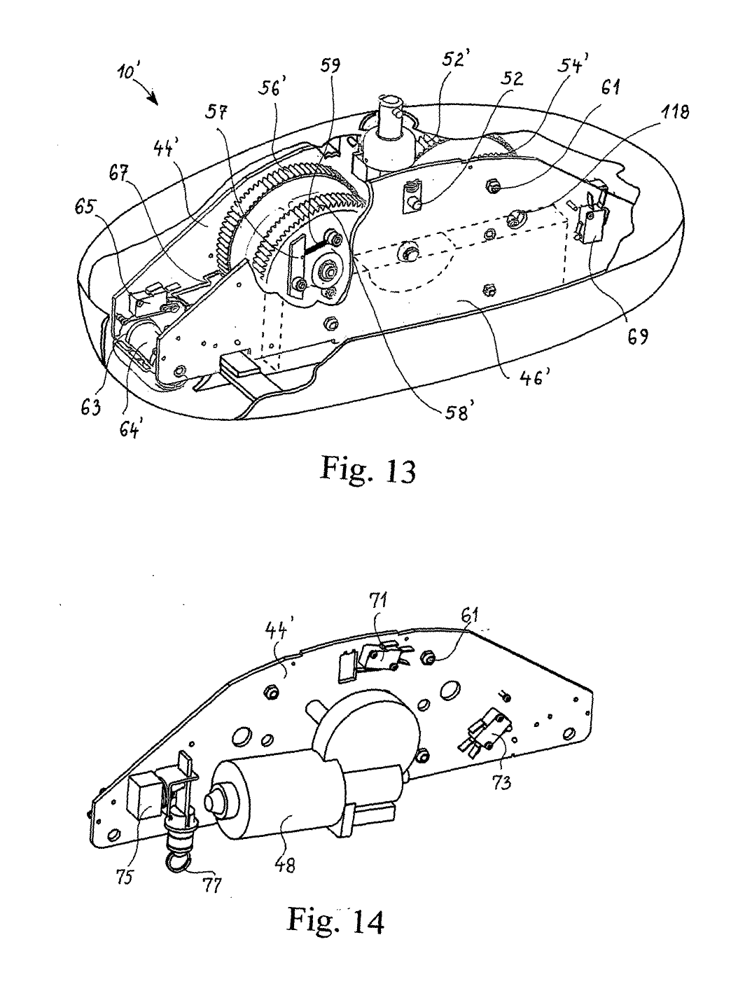

FIG. 13 is a perspective, schematic and partly cutaway view of a further and preferably preferred embodiment of the patient or person lift according to the present invention,

FIG. 14 is a perspective and schematic view of a detail of a supporting component of the embodiment of the patient or person lift according to the present invention shown in FIG. 13,

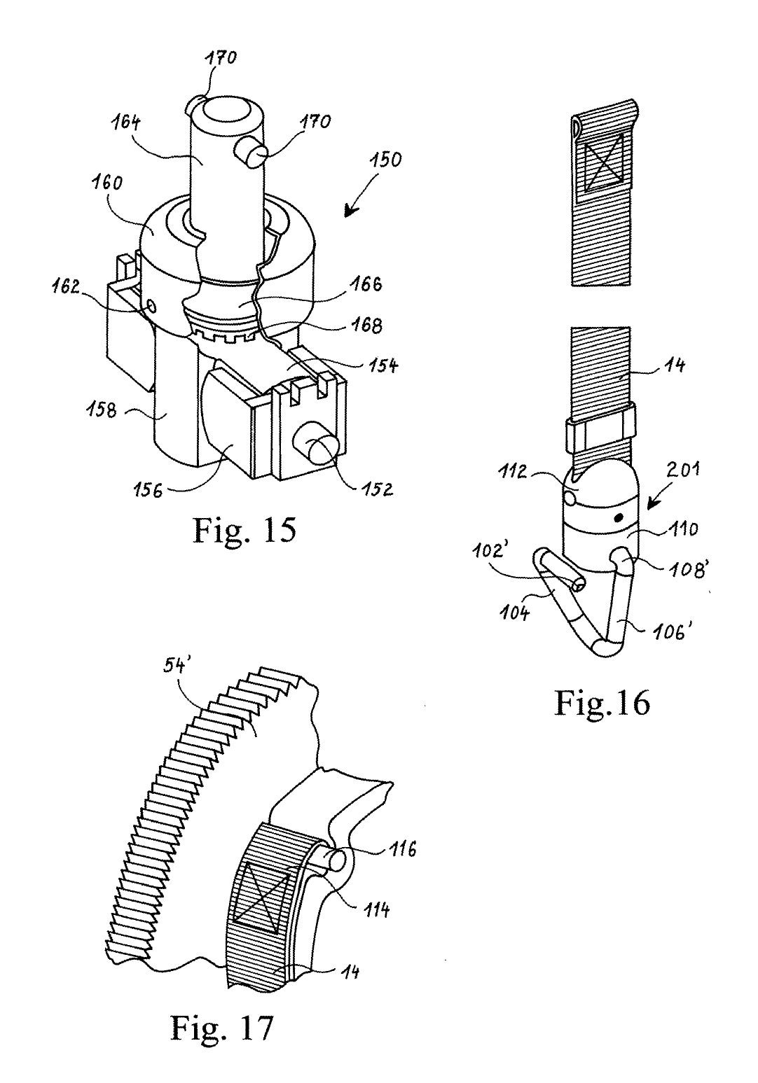

FIG. 15 is a further detail of a component of the embodiment of the patient or person lift according to the present invention shown in FIG. 13,

FIG. 16 is a schematic view of a further embodiment of the self-blocking sling suspension fitting,

FIG. 17 is a perspective, schematic and partly cutaway view illustrating a detail of the fixation of the belt relative to the wheel, and

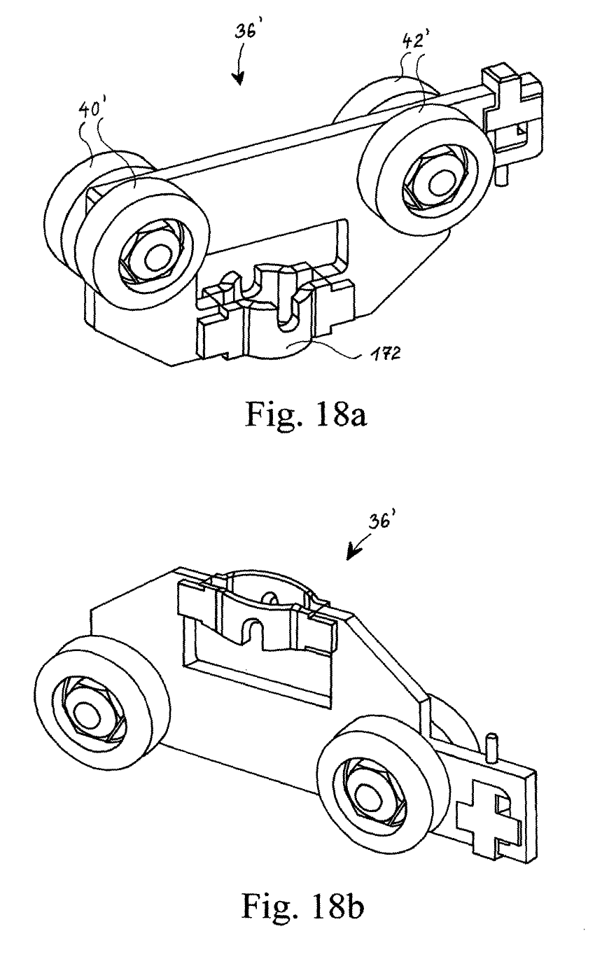

FIGS. 18a and 18b are perspective and schematic views of the carriage of the further and advantageous embodiment of the rail mounted patient or person lift according to the present invention shown in FIG. 13.

In FIG. 1, a first and advantageous embodiment of a patient or person lift according to the present invention is shown. The lift is a so-called rail-mounted lift which is mounted for displacement along a rail 12. The lift comprises a carriage 10 from which two belts 14 and 16 extend downwardly and from which belts a sling 18 is suspended by means of two suspension fittings 20 and 22 and in which sling a person 24 is sitting. In FIG. 1, the person holds a remote control unit 26 by means of which a motor included within the carriage 10 may be actuated for lowering or raising the sling 18 by extending or shortening, respectively, the two belts 14 and 16 as will be described in greater details below. Between the two belts 14 and 16, a bar 28 extends, which bar serves to maintain the belts 14 and 16 in a specific spaced apart relationship, as the two belts 14 and 16 are to be maintained in a mutual parallel orientation while raising or lowering the sling 18. The housing of the carriage 10 is designated the reference numeral 34 and in the embodiment shown in FIG. 1, the housing 34 is through a bar 30 connected to an additional unit 32, which unit constitutes a pushing and pulling motor unit or a tractor unit, which is controlled from the remote control unit 26 and includes a motor for pushing the carriage 10 to the left or alternatively pulling the carriage 10 to the right. It is to be understood that the tractor unit 32 is an optional or accessory unit.

The lift shown in FIG. 1 is a raising or lowering lift, however, as is well known in the art, the structure may be modified into a self propelling structure in which a further motor or further motors are included within the carriage co-operating with the rail 12 for moving the carriage 10 of the lift to the left or to the right by actuating the motor or the motors.

In FIGS. 2, 3 and 4, sectional views are presented, in which the carriage 10 is shown in greater details. The carriage 10 comprises an outer housing shell 34 which is preferably made from light weight mechanically stable plastics material such as ABS or similar high strings plastics material. As is illustrated in FIGS. 2 and 4, the carriage is composed of two parts, a top part 36 and a bottom part enclosed within the housing 34. The top part 36 includes a metal bracket 38 which supports two wheels 40 and 42, which are received within the rail 12. In FIG. 4, only a single wheel 40 is shown, however, according to an alternative embodiment, an additional wheel positioned symmetrically relative to the metal bracket 38 may be provided for establishing a more stable supporting structure. The bottom part 34 of the carriage is connected in a rotatable swivel and bayonet coupling to the top part 36, as will be described in greater details with reference to FIGS. 5 and 6 and includes two spaced apart metal plates 44 and 46, which support a motor 48 having an output shaft which is connected in a worm gear to a pinion 50 shown in FIG. 2.

The pinion 50 co-operates with two pairs of toothed wheels, the one pair being designated the reference numeral 52 and 54 and the other pair being designated the reference numerals 56 and 58. Between the two toothed wheel pairs 52 and 54, a first belt receiving roller 60 is sandwiched, a second belt receiving roller 62 being received between the two toothed wheels 56 and 58. The belt receiving roller 60 co-operates with the belt 14 and the belt receiving roller 62 co-operates with the belt 16. The belt 16 is guided round a pin 64 and similarly, the belt 16 is guided round a pin 66. The pins 64 and 66 serve the purpose of maintaining the belts 14 and 16 in a parallel spaced apart relationship as is illustrated in FIG. 1 and for allowing the width or spacing between the belts 14 and 16 to be adjusted to the width of the person 24 using the lift, the pins 14 and 16 are preferably repositionable and adjustable, as is illustrated in FIG. 9, as the pin 64 may be shifted between a total of four positions 69 in a cut-out 68 of the plate 44 and received and locked in a specific recess of the cut-out 68 and locked by means of a locking block 70.

As mentioned above, the bottom part of the carriage including within the housing 34 is received in a swivel and bayonet connection in the top part 36 as is illustrated in greater details in FIGS. 5 and 6. In FIGS. 5 and 6, the bottom part of the carriage enclosed within the housing 34 is shown in a reduced scale and from the top of the housing 34, a pin 72 extends upwardly, which pin has a transversal locking pin 74 shown in FIG. 6. The wheel supporting plate 36 constituting the top part of the carriage has two fins extending downwardly from the rail 12 between which fins two clamps 76 are positioned. The two clamps are each provided with a top recess 78 in which the transversal pins 74 of the upwardly protruding pin 72 may be received and locked for preventing the bottom part 34 of the carriage to be unintentionally disconnected from the top part 36. Consequently, the bottom part of the carriage may only be disconnected from the top part 36 provided the bottom part 34 is lifted and at the same time, the bottom part needs to be positioned at a specific location relative to the rail 12 at which location, two cuts are provided in the rail for allowing the racing of the bottom part. In FIG. 6, the spacing between the top surface of the clamp 76 and the lower side of the rail 12 prevents the bottom part 34 to be disconnected from the top part 36, as the pins 74 are simply blocked from being disconnected from the top recess 78. An additional or alternative bayonet or similar locking device may optionally be provided for further preventing any unintentional disconnection between the bottom part 34 and the top part 36 of the carriage.

In FIG. 7, the rail 12 is shown, which rail is illustrated constituting a transversal component of a frame including two side rails 80 and 82, in which the rail 12 is mounted displaceably for allowing the carriage 32 to be moved in an orthogonal motion system, as is illustrated by two pairs of double arrows 84 and 86. The double arrows 84 illustrate the possible motion of the carriage 10 along the rail 12 and the double arrows 86 illustrate the motion of the transversal rail 12 relative to the side rails 80 and 82. It is to be understood that the patient or person lift according to the present invention may be used in connection with a mono rail system or as discussed above, in combination with a rail concealed within the ceiling of a room or any other rail system.

In FIG. 10, the advantageous version of the power supply system of the patient or person lift is shown. In FIG. 10, the remote control unit 26 is connected through its multi core cable 90 to the housing 34 of the carriage 10 of the lift. The remote control unit 26 is configurated as a charging connector having a plurality of connectors 92 for co-operating with co-operating connectors 94 of a receptacle 96, which constitutes a charger station, which is connected to a AC mains supply adaptor 98. In FIG. 10, the rechargeable batteries, such as Ni Mh batteries or similar rechargeable batteries contained within the carriage 34 are charged through the multi-core cable 90, which carries the electric power from the AC mains adaptor 90 to the batteries.

In FIG. 11, a modified version of the remote control unit is shown designated the reference numeral 26′. The remote control unit 26′ is intended to be connected to a separate battery power pack 26″, which is connected to the power supply cords of the multi-core cable 90 through connectors 94″. In the system shown in FIG. 11, the battery power pack 26″ is simply shifted from the remote control unit 26′ to a remote charging station and substituted by a previously fully charged battery power pack.

In FIG. 12, an electronic circuitry of the power supply unit of the patient or person lift is shown, which diagram is a basically conventional micro processor based diagram, in which the voltage present on the terminals of the battery power pack is monitored by means of a resistor including within a circular marking 120 and in which diagram the current supplied from the battery power supply is monitored by means of three series resistors included within a circular marking 122. No detailed description of the diagram is presented, as it is contemplated that no additional description of the electronic circuitry is needed. The diagram generally serves the purpose of ensuring that the capacity of the battery power supply is always sufficient for performing a complete lift or the maximal allowable load and thereby to ensure that a person or patient using the patient or person lift may always safely operate the patient or person lift without risking being unintentionally positioned in an adequate lifted position without being able to be lowered or raised to e.g. a chair or bed.

In FIGS. 8a-8d, the suspension fitting 20 of the belt 14 is shown in greater details illustrating a self-locking feature of the fitting. The fitting 20 is, as is illustrated in FIG. 8a, provided with a horizontal part 102 connected to the outer end of the belt 14. The horizontal part 102 is connected to a leg 104, which is further through a V-bend connected to a further leg 106, which is somewhat longer than the leg 104 and is connected to a further horizontal part 108. The fitting 120 is used, as is illustrated in FIGS. 8b-8d for providing a self-arresting function as an outer end of a strap 19 of the sling 18 is threaded on to the outer end of the horizontal part 108 of the fitting 20, as is illustrated in FIG. 8b and moved along the longer leg 106 to the V-shaped junction between the two legs 104 and 106 as is illustrated in FIG. 8c, whereupon the pull in the belt 19 as is illustrated in FIG. 8d causes the horizontal part 108 of the fitting 20 to be positioned juxtaposed and closely adjacent the belt 14 and preventing the belt from unintentionally being shifted along the leg 106 and removed from the fitting 20. The self-closing ability is believed to originate from the provision of the longer leg 106 of the fitting as compared to the leg 104, which longer leg 106 is connected to the free outer end of the fitting on which free outer end the strap 19 of the sling is to be threaded on to the fitting.

In FIG. 13, a further and presently preferred embodiment of the patient or person lift according to the present invention is shown. In the description of the second and presently preferred embodiment of the patient or person lift according to the present invention, no detailed description is made of components or elements previously described and components or elements identical to components or elements, respectively, described above with reference to the first embodiment of the person or patient lift according to the present invention is designated the same integer as used in the above described figures, whereas components or elements differing geometrically from the components or elements, respectively, described above, however having the same function as a specific component or a specific element, described above, is designated the same integer, however, added a marking for identifying the geometrical difference.

The second and presently preferred embodiment of the patient or person lift according to the present invention shown in FIG. 13 and designated the reference numeral 10′ in its entirety is to be described in greater details relative to certain additional features included in the second embodiment as compared to the first embodiment described above with reference to FIGS. 1 and 2.

In FIG. 13, the wheel 58′ is at its outside provided with a rotatably journalled metal component or pin 57, which constitutes a centrifugal brake element, as the metal plate is acted upon by a spring 59, which keeps the metal plate 57 in a first retracted position, in which the outer end of the metal pin is positioned close to the central axis of the wheel 56′ and 58′, however, provided the wheel 56′ and 58′ start to rotate freely, e.g. in case the power to the drive motor is not present and the weight of the patient or person hanging in the belts of the lift causes a swift unwinding of the belt, the metal component or pin 57 is forced outwardly against the force generated by the spring and hits an inwardly protruding pin not shown in FIG. 13, however corresponding to a pin 61, which co-operates with the corresponding metal component or pin of the wheel 54′.

In FIG. 13, the roller 64 for the guiding of the corresponding belt is shown, which roller is journalled in a further bushing 63, which is journalled so as to allow a certain and limited rotation of the bushing relative to the supporting plates 44′ and 46′ and also a limited vertical motion of the bushing 63 relative to the supporting plates 44′ and 46′. The bushing 63 consequently constitutes a further guide for the guiding of the belt from the roller 64 into a specific and well-defined angular orientation relative to the housing 10′. The vertical journalling of the bushing 63 allows the bushing to serve as a further means for preventing the corresponding belt to run freely from the roller 64′, as any slack of the belt causes the bushing 63 to raise and consequently, activate a switch 65, which then turns off the motor. The lift 10′ further includes a pair of detector arms, one of which is shown in FIG. 13 and designated the reference numeral 67. The arm 67 and similarly the arm co-operating with the belt of the wheels 52′ and 54′ rests against the belt and provided any slack occurs in the belt, the arm 67 activates a micro switch similar to the switch 65 for causing the power to the motor to be turned off. In FIG. 13, a switch 69 is shown co-operating with the detector arm of the wheels 52′ and 54′ corresponding to the detector arm 67.

In FIG. 14, a detail of the plate 44 is shown illustrating additional switches 71 and 73 and the motor 48 and further a manual operable switch 75, which may be actuated by pulling in a ring-shaped actuator 77. By actuating the switch 75, power is supplied from an internal minor back-up battery of the lift 10′ for allowing the motor 48 to unwind the belts from the pair of wheels 52′, 54′ and 56′, 58′ and in doing so, allowing a person or patient hanging in the belts to be lowered slowly in case the power from the main battery supply is not available or the main battery supply has reached a low power level.

The switch 71 shown in FIG. 14 co-operates with a top suspension element shown in FIG. 15, which element is in its entirety designated the reference numeral 150. The element 150 basically comprises a horizontal through-going shaft 152, which is received in corresponding suspension bushings of the walls 44′ and 46′ co-operating with a pair of switches, one of which is shown in FIG. 14 and designated the reference numeral 71 for preventing that the motor 48 is unintentionally actuated in case the housing of the lift 10′ is raised as is to be described below for disconnecting the housing 10′ from its corresponding carriage, such as the carriage 36 shown in FIGS. 2 and 5 or alternatively the carriage 36′ shown in FIGS. 18a and 18b. The through-going shaft 152 of the element 150 shown in FIG. 15 is surrounded by a rubber encasing 154 serving as a soft suspension element for noise reduction and for allowing the carriage, in which the lift 10′ is suspended to follow a track slightly different from an ideal guiding track line without causing the lift 10′ to tilt or swing or otherwise move, which might else cause discomfort to the patient or person or further excessive mechanical impacts to the guiding rail.

The element 150 has an outer housing 156 enclosing the rubber suspension 154 and is provided with a central body element 158, which is fixated to a ring-shaped top element 160 by means of a through-going pin 162. Within the ring-shaped top element 160, a suspension stem 164 is received. The element 164 has a bottom plate element with bottom teeth 168, which may engage with the through-going pin 162. Provided the element 150 is suspended in its carriage, the teeth 168 are disengaged from the pin 162 allowing the entire lift to rotate round the axis defined by the suspension stem 164, whereas provided the housing of the lift 10′ is raised, for allowing the element 150 to be disengaged from the carriage, such as the carriage 36 shown in FIGS. 2 and 5 or alternatively the carriage 36′ shown in FIGS. 118a and 118b, the teeth 168 engage with the pin 62 and consequently locks the stem 164 to the housing allowing the stem 164 to be raised and turned for disengaging the horizontal outwardly protruding pins 170 of the stem 164 from the corresponding suspension of the carriage.

In FIG. 16, a further embodiment of the suspension fitting 20′ is shown differing from the above described fitting 20 shown in FIGS. 8a-8d in that the element 102′, 104′, 106′, 108′ is journalled in a bottom bushing 110, which is connected through a vertical rotation axis to a top bushing 112 to which the belt 14 is fixated.

In FIG. 17, a feature of the fixation of the belt 14 relative to the wheel 56 is shown, as the belt 14 is provided with a closed loop part 114, which is mounted on a bolt of the wheel assembly 56′, 58′. In FIG. 13, an aperture 118 is shown, in which aperture a bolt is exposed, which bolt belongs to the set of wheels 52′, 54′ and corresponds to the bolt 116 of the pair of wheels 56′, 58′. As the bolt 116 is positioned in registration with the aperture corresponding to the aperture 118, the bolt may easily be demounted by means of an appropriate piece of tool, such as a hexagonal key, and after the removal of the bolt 116, a worn out belt may be removed and a new belt 14 may be mounted on the bolt 116, which is then tightened for reassembling the wheel set 56′, 58′.

In FIGS. 18a, 18b, a further or second embodiment of the carriage 36′ is shown comprising two pair of wheels 40′ and 42′ and further disclosing a central cradle for the receiving of the pins 170 of the stem 164 shown in FIG. 15. The cradle is designated the reference numeral 172.

The second and presently preferred embodiment of the patient or person lift 10′ described above with reference to FIGS. 13-17 includes an electronic circuitry for the controlling of the motor 48, which electronic circuitry resembles the electronic circuitry shown in FIG. 12 and has its micro processor configurated so as to make a soft start of the motor for reducing the overall power consumption and further reducing any discomfort to the patient or person hanging from the lift by means of the belts 14 and 16. The electronic circuitry also preferably includes provisions for preventing any actuation of the motor during changing of the main battery, except the above described lowering of the patient or person by actuating the switch 75 and operating the motor by means of the internal back-up battery, thereby ensuring that the main battery is not used until a complete recharging has taken place.

Although the present invention has been described above with reference to a specific and preferred embodiment, it is contemplated that numerous modifications and changes may be made, as will be evident to a person having ordinary skill in the art without departing from the scope of the invention as defined in the appending claims. Consequently, any amendments or modifications of the above kind obvious to a person having ordinary skill in the art is to be construed part of the present invention.

1. An electrically powered, rail-mounted patient or person lift, comprising:
a carriage for displacement along an overhead rail, having a housing, said housing including:
an electric motor having an output shaft;
two belts suspended from said housing for the mounting of a patient or person support;
two belt-receiving rollers, each having an outer cylindrical surface for receiving a respective lifting belt and co-operating with said output shaft of said electrical motor for rotating in opposite directions at the same rotational speed driven by said output shaft, thereby collecting said belts when rotating said output shaft in the one direction and discharging said belts when rotating said output shaft in the opposite direction; and
a power supply unit for the delivery of electrical power to said electrical motor.

2. The lift according to claim 1, said electric motor being a DC motor and said power supply unit being a battery supply including one or more rechargeable batteries.

3. The lift according to claim 2, said one or more rechargeable batteries being housed within a battery power pack and being rechargeable by means of a separate main supply powered recharging station.

4. The lift according to claim 2, said power supply unit including a monitoring circuit monitoring the capacity of said one or more rechargeable batteries for preventing said electric motor from being actuated, provided that said battery capacity is below a specific threshold.

5. The lift according to claim 1, further including a remote control unit communicating with said power supply through at least one of a wired connection and a wireless link.

6. The lift according to claim 5, said remote control unit including said one or more rechargeable batteries.

7. The lift according to claim 1, said belt receiving rollers being journalled on respective journalling axles and having toothed wheels co-operating with a pinion of said output shaft.

8. The lift according to claim 7, said belt receiving rollers having two toothed wheels each sandwiching a respective belt receiving roller.

9. The lift according to claim 1, said belts being guided from said belt receiving rollers round positionable guiding pins.

10. The lift according to claim 1, wherein said housing comprises a two part housing having a top part including a pair of wheels for co-operating with said overhead rail and a bottom part including said electric motor and said two belt receiving rollers, said bottom part being journalled rotatably around a vertical axis relative to said top part.

11. The lift according to claim 10, said bottom part being connected to said top part through a bayonet like swivel connection allowing said bottom part to be disconnected from said top part.
